(19) United States
(12) Patent Application Publication
(10) Pub. No.: US 2005/0132347 A1
(43) Pub. Date: Jun. 16, 2005

(54) System for controlling the use of a software application on a plurality of computers

(76) Inventors: Eric David Harper, Reading Berks (GB); David Keith Meredith, Berks (GB)

Correspondence Address: PATENT DEPARTMENT;MACROVISION CORPORATION, 2830 DE LA CRUZ BLVD., SANTA CLARA, CA, 95050, US

(21) Appl. No.: 10/736,038

(22) Filed: Dec. 15, 2003

(51) Int. Cl. G06F 9/44

(52) U.S. Cl. 717/168

(57) ABSTRACT

The present invention provides a computer system comprising a plurality of computers, each capable of running a given software application, and a server. A transaction arrangement is operable between each computer and the server for activating and deactivating a license for the given software application selectively at each computer. In the preferred embodiment, each computer comprises an application store for storing a copy of the given software application, and a license store for storing details of the license including license rights. The server comprises a data store for storing a serial code for the given software application, a data store for storing an identification code for any computer where the license is activated, and data store containing details of the license rights allocated to each computer. The transaction arrangement involves transmitting a request from a respective computer to the server to activate a license at that computer, a check by the server as to whether a license is available, and the transmission of a response by the server indicating the availability of the license and, if so, the license rights awarded.

### BACKGROUND OF THE INVENTION

1. Field of the Invention

The present invention relates to the field of controlling the use of a given software application or computer program on a plurality of computers, and has particular application in the field of managing the authorisation of licenses for a software application, and the allocation of particular rights under the licenses, for a plurality of computers.

2. Description of the Prior Art

A system for protecting a computer program against unauthorised copying in a network including a number of computers connected to a file server is disclosed in an article entitled “Software Protection” by Doug and Dale Cabell, published in Micro Communications, Vol. 2, No. 5, May 1985, pp. 35-37. According to this article, individual users are required to supply the serial number of the program to the server, and are barred from use of the program if the serial number supplied does not match that stored in a file server. The maximum number of users of the program may also be limited by supplying a message to new users when the set number has been exceeded, following which such new users must wait until an existing user has finished using the program before they can proceed.

A system for controlling the availability of licenses for a given computer program for use by a number of computers or nodes in a computer network is disclosed in U.S. Pat. No. 5,390,297. According to this patent, a plurality of nodes connected in a network each have a respective license manager for detecting the availability at that node of a valid license to operate the computer program. In the absence of a valid license, the license manager of the local node searches the other, remote, nodes for such a valid license. If the valid license is located at another node, the license manager of the first or local node saves the license information in the memory of the local node and creates a new license in the local node, at the same time requesting the remote node to erase the license so that the transferred license is no longer available on the remote node. In this way, licenses may be transferred between the different nodes in the network, and the number of copies of the given computer program that are in use may be controlled accordingly.

A drawback with this prior art arrangement is its complexity, given the need for a license manager, with consequent storage capacity, at each individual node in order simply to control the allocation of licenses for use of the computer program amongst the different nodes in the network. The prior system concerns concurrent licensing of one computer program for use by a number of different nodes in a network, and the transfer of a license from one node to another as and when there is an immediate need for a license at the other node and one is not locally available. As soon as a transfer has taken place, the license is erased from the first node and therefore no longer exists there.

Thus, there is no central management arrangement for keeping track of whether or not the computer program is available at any particular node, or for monitoring the use of the computer program by a particular node. Simply, if a license is available at a node, the computer program can be executed. If not, a search through all the nodes has to be conducted. Then, on each occasion that the license is transferred from one node to another, the original license is erased and the computer program can no longer be executed.

Such an arrangement results in a considerable duplication of processing and requires a substantial storage capacity at each individual node. In addition, it has the disadvantage that the overall license management ability is limited. Further, the users of such networks may experience access problems if all of the licenses are allocated, even if in some cases only a small proportion of the computer program is actually in use at a given node.

There is a need for a simplified system for managing the allocation of licenses for a given software application amongst a plurality of computers. There is also a significant need for a more flexible license management system permitting a wider range of license options and user access to the given software application.

### SUMMARY OF THE INVENTION

An object of the present invention is to provide new systems and methods for controlling the use of software applications or computer programs.

Another object of the present invention is to manage the allocation of licenses for software applications to a plurality of computers in a computer system.

A further object of the present invention is to manage the allocation of licenses for a given software application to a plurality of computers in a computer system by means of a server.

A further object of the present invention is to control the issue of rights under a license amongst a plurality of computers in a computer system.

According to a first aspect of the invention, there is provided a computer system comprising: a plurality of computers, each capable of running a given software application, a server having a server store, communication means respectively permitting communication between each said computer and said server, and a transaction arrangement operable respectively between each said computer and said server by way of said communication means for enabling a predetermined use of said given software application by respective ones of said computers, in which said server controls said predetermined use by means of said transaction arrangement and according to conditions stored in said server store.

Preferably, the transaction arrangement comprises a license management system for verifying the availability for a respective computer of a license for the software application.

The license management system may advantageously also control license rights available under the license, and be arranged to configure a respective computer to operate according to such license rights.

According to a further aspect of the invention, there is provided a license management system for controlling the use of at least one given software application respectively on a plurality of computers, said system comprising: an application store associated with each said computer for storing a copy of said given software application; a remote data store for storing information concerning a license to operate said at least one given software application; a remote data store for storing identification information relating to said at least one given software application; a remote data store for storing identification information relating to each said computer; and a transaction arrangement operatively linking said application store, said license store, said application directory and said computer directory, said transaction arrangement being responsive to a request from a respective said computer for use of said at least one given software application to verify whether said at least one given software application is available for use by said respective computer and to transmit to said respective computer a said license to use said at least one given software application in the event that said at least one given software application is so available.

According to a further aspect of the invention, there is provided a computer programmed to perform a transaction for enabling the operation of a given software application, the transaction arrangement comprising: creating a license file for a license to operate said given software application; assigning to said license file a serial number representing said given software application; assigning to said license file an identification code representing said computer; transmitting to a server a request to execute said given software application; transmitting with said request said serial number and said identification code; in response to a server reply updating the license file with information concerning the availability of said license; and reading said license file for establishing whether said given software application can be executed.

According to another aspect of the present invention, there is provided a method for controlling the execution of a given software application on a plurality of computers in a computer system including a server, said method comprising the steps of: creating a license file on a respective said computer for a license to operate said given software application; assigning to the license file an identification code representing said respective computer; transmitting to a server a request to execute said given software application at said respective computer; transmitting with said request a serial number for said given software application and said identification code; in response to a reply from said server updating the license file with information concerning the availability of said license; and reading said license file for establishing the status of said license at said respective computer.

### BRIEF DESCRIPTION OF THE DRAWINGS

The present invention will be described further, by way of example, with reference to the accompanying drawings showing the preferred embodiments, in which:

FIG. 1 is a block diagram of a computer system embodying the present invention;

FIG. 2 is a block diagram showing a database table of a server in the computer system of FIG. 1;

FIG. 3 is a flow chart representing a transaction between a client and a server of the computer system of FIG. 1 according to a first embodiment of the invention;

FIG. 4 is a flow chart showing the transaction of FIG. 3 in greater detail;

FIG. 5 is flow chart showing a further transaction between the client and the server according to the first embodiment of the invention;

FIG. 6 is a flow chart showing a still further transaction between the client and the server according to the first embodiment of the invention;

FIG. 7 is a flow chart corresponding to FIG. 4 showing a transaction between the client and the server according to a second embodiment of the invention; and

FIG. 8 is a flow chart corresponding to FIG. 5 and showing a further transaction between the client and the server according to the second embodiment of the invention.

### DESCRIPTION OF THE PREFERRED EMBODIMENTS

3. General Description

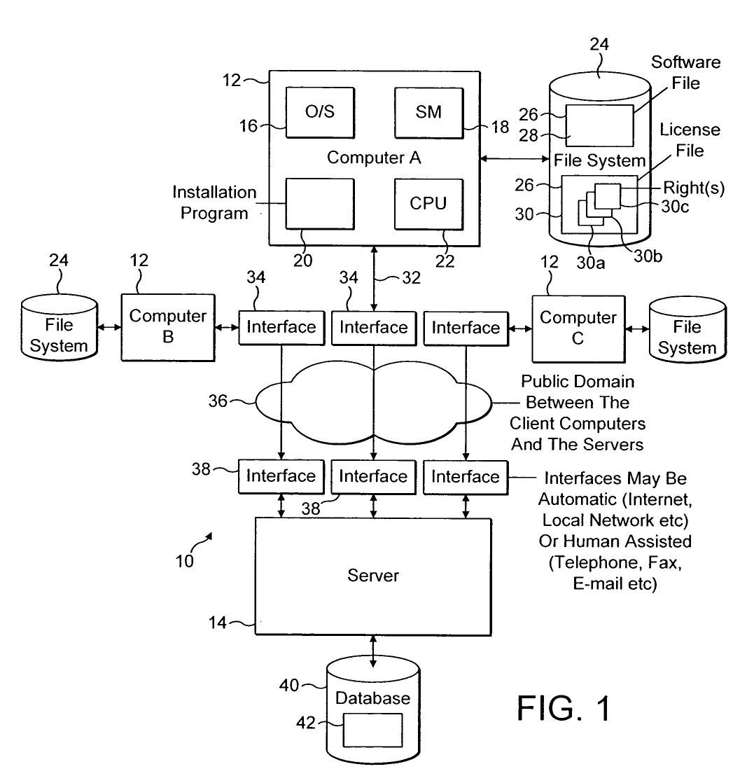

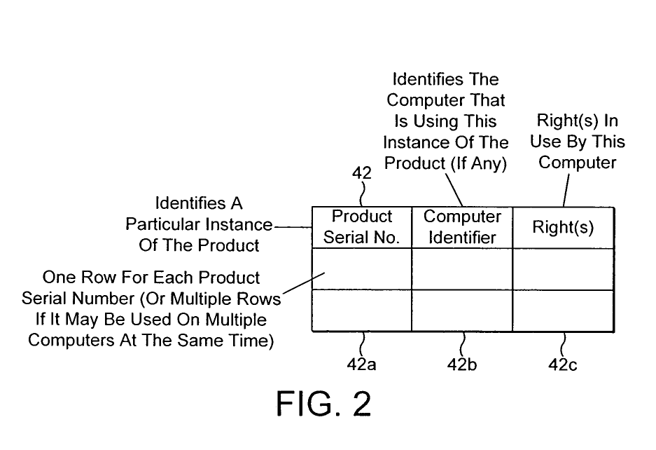

Referring initially to FIGS. 1 and 2, a computer system 10 capable of running a given software application is shown. The system comprises a number of clients 12, shown here as computers A, B and C, which may be located at the same site or at a plurality of different sites and which may be under the control of the same entity or under the control of different entities. Each client 12 is able to communicate directly with a server 14, for example a separate computer at a remote location, for the purpose of obtaining and activating a license to execute the software application and of establishing conditions for use of the software application, i.e. license rights. For the sake of simplicity, in the present example where there are three computers capable of executing the software application, it is assumed in the following description that only one such computer may be authorised to execute the software application at any one time, which initially is computer A.

The configuration of computer A and its means of communication with the server 14 will now be described. It will be appreciated that computers B and C have a similar configuration and are capable of similar interchanges with the server 14 and therefore these will not be described.

As shown in FIG. 1, computer A comprises an operating system 16, a system memory 18, an installation program 20 and a central processing unit (CPU) 22. The computer also has a peripheral storage device 24, such as a disk drive. The disk drive 24 contains a file system 26 including a software file 28 containing the software application whose use is controlled by a license. Similar software files 28 are included in the disk drives 24 of computers B and C. As soon as the software application is executed on Computer A, the application creates a license file 30, which initially contains no license activation rights. When computer A wishes to execute the software application, the computer must first activate a license to do so, and this is effected by means of a transaction between computer A and the server 14.

For this purpose, a communication channel 32 must be opened between computer A and the server 14. As shown, computer A has a computer interface 34 capable of exchanging communications across the public domain 36 with a server interface 38 for the server 14. For example, the interfaces 34, 38 may be in the form of modems, and the public domain 36 may be the internet, in which case communication between computer A and the server 14 may be automatically effected. However, other forms of communication channel 32 are also possible, including a public domain in the form of a local telephone network 36, and human assisted interfaces 34, 38 involving the use, for example, of telephone, fax or e-mail.

The server 14 is arranged to control the allocation of licenses to computers A, B and C, and also their activation and deactivation. For this purpose, the server 14 has a database 40 containing a database store or table 42 with information pertaining to a number of licenses. FIG. 2 shows additional details of this table, which may include a column 42a for the serial number of each software application that is available to the various clients 12. The serial number column will include one entry of the serial number for each available license, i.e. one entry in the present example for the software application. If two licenses were available for the software application, and hence the application could be used simultaneously on two of the computers in the computer system, then there would be two entries for that serial number in the serial number column 42a. Likewise, further such serial numbers for different software applications may also be stored in the serial number column 42a.

The database table 42 also includes a computer identification column 42b. Each computer in the system is allocated a unique identification code, and when the license for a particular software application is activated at that computer the identification code is stored in the column 42b. The license table 42 in the database 40 also includes a data column 42c that describes the license rights, in which may be stored details of the rights available under the license, eg its term and expiry date, and whether certain features only of the software application are authorised.

Corresponding license rights records 30a, 30b and 30c will eventually be created in the license file 30 of computer A, as described below.

### 4. First Embodiment

### Invariable License Rights

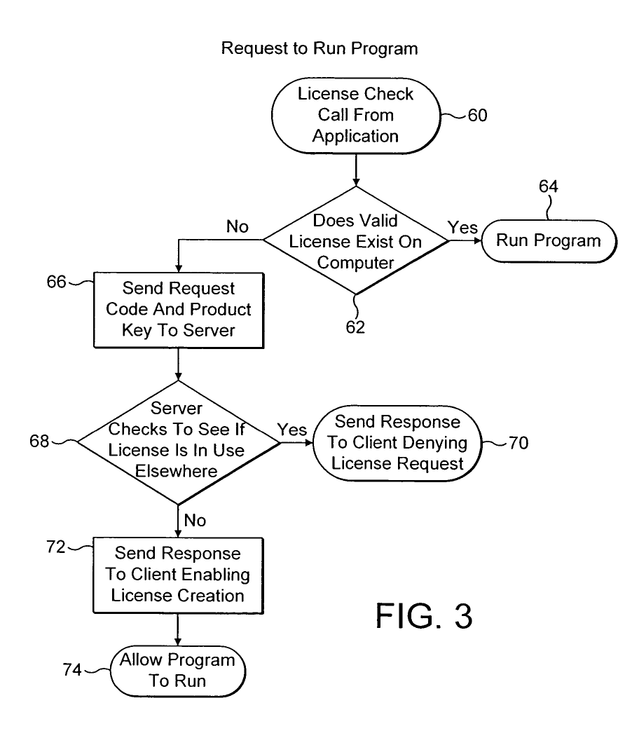

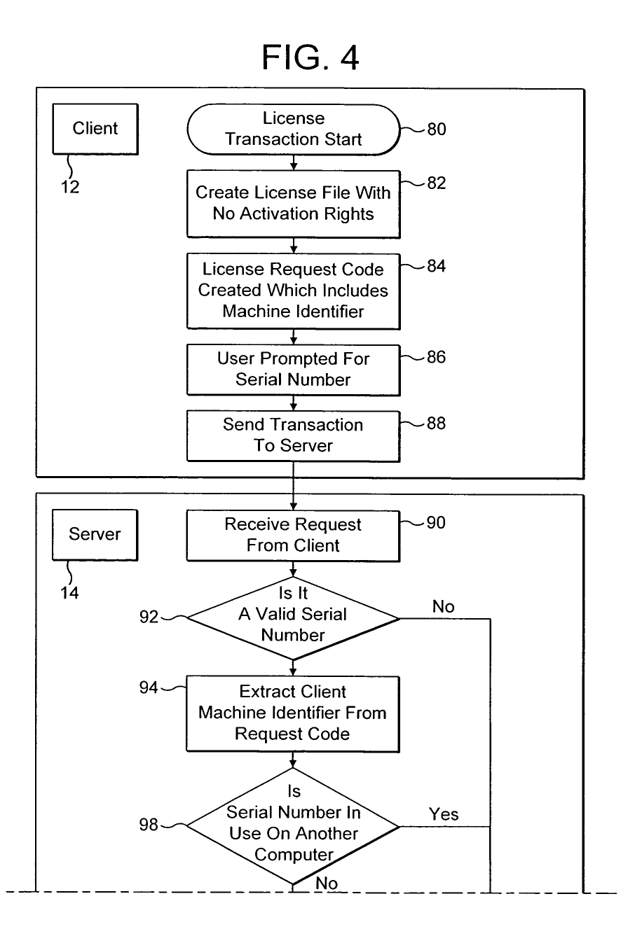

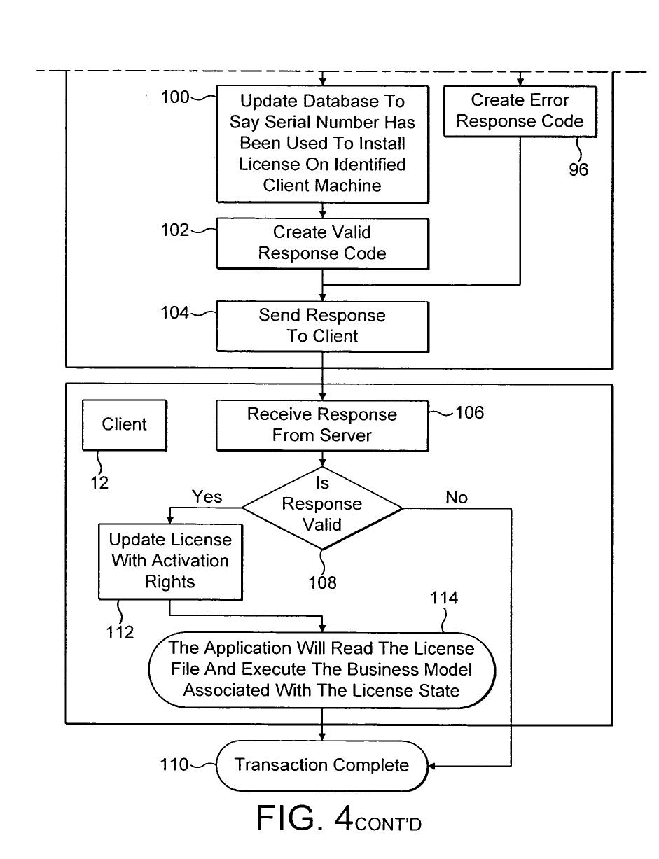

The transaction occurring between computer A and the server 14 when the software application is first installed will now be described with the aid of the flow charts shown in FIGS. 3 and 4.

Firstly, computer A is switched on and the software application is installed by means of the installation program 20. The software application that is to be executed on computer A is loaded into the disk drive 24 and is stored in the software file 28. The software application immediately creates a license file 30. At this point, the license file 30 has no activation rights because no license has yet been activated.

The software application sends out an enquiry in step 60 as to whether a valid, i.e. activated, license already exists in the license file 30 in computer A. In response, computer A checks in step 62 whether or not a valid license exists in the file 30. If yes, computer A executes the software application. However, in the present instance where the software application has only just been loaded into the disk drive 24, the answer will be no and the computer will proceed to step 64, in which the computer issues a license request to the server 14. The server 14 responds in step 66 by making a check through its own database store 42 to see whether the license has been activated in one of the other computers B or C. If yes, the server sends a response in step 68 to computer A denying the license request so that no license is activated in computer A authorising it to execute the software application. If the answer to the check in step 66 is no, the server 14 sends a response to computer A in step 70 enabling computer A to activate the license and then in step 72 to execute the software application accordingly.

This process is shown in greater detail in FIG. 4. As shown in FIG. 4, loading the software application into the software file 28 initiates a license transaction in step 80. The software application first creates the license file 30 in step 82. The license file 30 at this stage contains no activation rights. Under the direction of the software application, computer A next formulates a license request including an identification code indicating the computer from which the request originates. This is step 84. In step 86, the software application prompts the client 12 to supply the serial number identifying the software application. The license request including the identification code and the serial number are then transmitted to the server 14 in step 88.

In step 90, the server 14 receives the license request from the client 12 and first checks in step 92 whether the request includes a valid serial number identifying the software application. If yes, the server 14 proceeds to step 94 and, if no, the server proceeds to step 96 and generates an “invalid” license response code. In step 94, the server 14 extracts the identification code for computer A from the license request, and proceeds to step 98 where the server 14 checks the columns 42a and 42b of the database store 42 to establish whether the software application using that serial number is in use on another computer, B or C. If yes, the server 14 proceeds once again to step 96 and generates an “invalid” license response code. On the other hand, if the check in step 98 establishes that the software application is not in use on another computer, then the server 14 proceeds to step 100 and updates its license files 42 to show that the software application identified in the serial number column 42a is in use in computer A as identified in the identification code column 42b. Server 14 then proceeds to step 102 and generates a “valid” license response code including information concerning the license rights available as specified in column 42c. The response code generated either in step 96 or in step 102 is then transmitted back to the client at computer A in step 104.

Client 12 at computer A receives the response code from the server 14 in step 106 and checks in step 108 to see whether the response code is one for a “valid” license or not. If not, the computer proceeds directly to step 110 signifying that the transaction is complete. In this event, the license file 30 is not updated and, at this point, will still have no activation rights. If, on the other hand, a “valid” license response code was received, computer A proceeds to step 112 and updates the license file 30 with the activation rights. At this point, computer A generates a number of file records 30a, 30b and 30c in the license file 30. The record 30a contains details identifying the software application. The record 30b contains details as to whether the license is activated or not, in this instance that it is activated, and the record 30c contains details of the license rights available under the license, or conditions of use. Subsequently, computer A proceeds to step 114, in which the software application reads the license file 30 and executes the license according to the conditions in the record 30c. Following this, computer A proceeds to step 110 since the transaction is now complete.

If for any reason, computer A accidentally erases its authorisation from the record 30b during this time, it can re-activate the license simply by making a new request to the server 14 in the step 66, as shown in FIG. 3. The server 14 will proceed through steps 68 and 72 as before and issue a new “valid” license code to computer A.

While computer A has an activated license in license file 30 and is running the software application in the software file 28, the other two computers B and C will not be able to install an activated license or activate a deactivated license in their own license file 30. In the event that one of these computers wishes to execute the software application, they will issue an enquiry to the server 14 as shown in FIG. 3 and proceed through steps 60, 62, 66, 68 and 70 to a state in which the server 14 denies the license request.

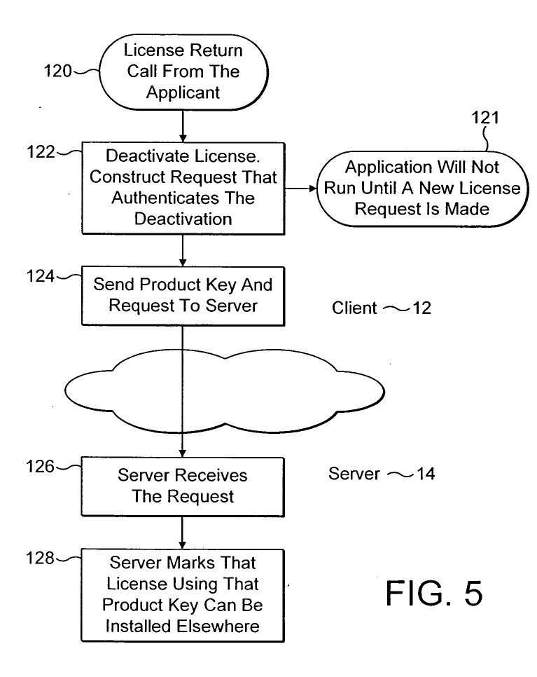

However, once the software application is no longer required by computer A, the computer enters another transaction with the server 14, as shown in FIG. 5. At this point, the software application generates a prompt as to whether the license in license file 30 is to be deactivated. If the user 12 indicates their assent in step in 120, computer A proceeds to step 122 and deactivates the license in license file 30 by updating the license record 30b. At the same time, computer A issues a deactivation request including the serial number for the software application and the identification code for computer A. Client 12 transmits this request to the server 14 in step 124. The server 14 receives the request in step 126 and in step 128 updates the database store 42 to show that the license is no longer activated at computer A and can be installed or activated at one of the other computers B or C.

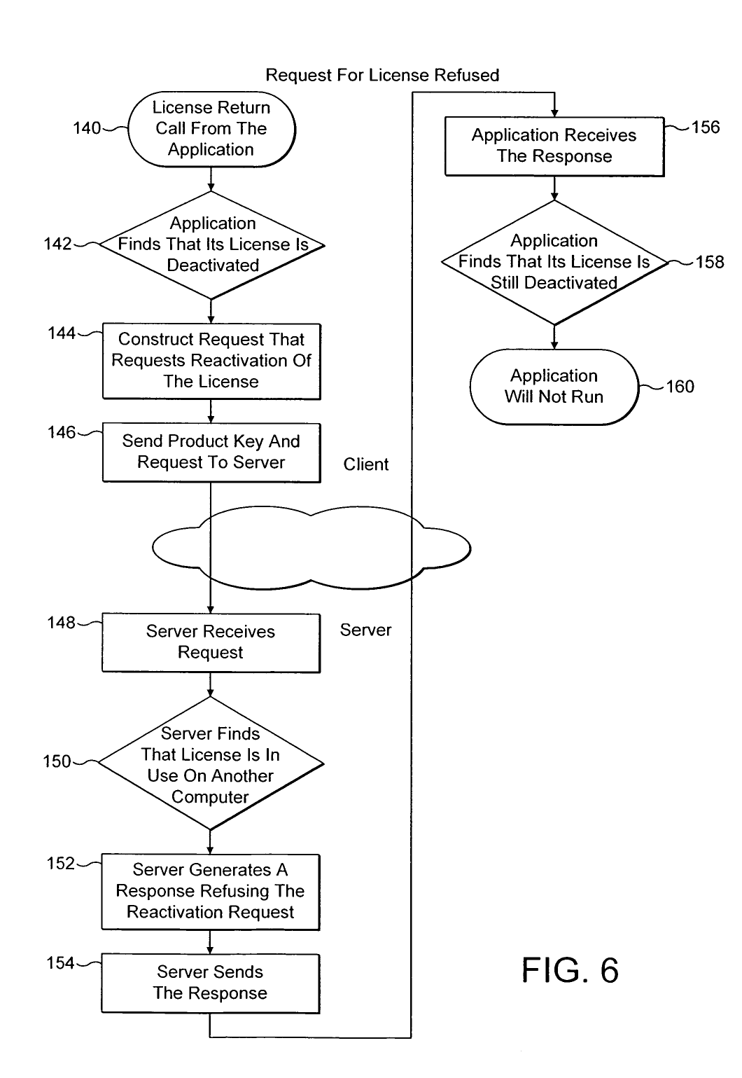

At this point, the license file 30 and the disk drive 24 of the computer A still contains the license and the license details but the license is deactivated. In order to resume execution of the software application under license, computer A will have to enter a further transaction with the server 14 and make a new license request for an activated license. If the license is available, such a request will be granted as before. On the other hand, if no license is available, the request will be refused. This latter event is illustrated in FIG. 6.

Referring to FIG. 6, the user 12 at computer A wishes to reactivate the license and generates a license return call in step 140. On checking whether a valid license exists at computer A (step 62 in FIG. 3), computer A discovers in step 142 that its license is deactivated. The computer proceeds to step 144 and generates a request to reactivate the license for transmission to the server 40. As before, this request will include the serial number for the application and the identification code for computer A. The request is transmitted to the server 14 in step 146, and is received by the server 14 in step 148. The server now checks the database store 42 and establishes in step 150 that the license has been activated on one of the other two computers, computer B or computer C. Consequently, the server generates a response in step 152 refusing the request to reactivate the license. This response is transmitted back to the client 12 at computer A in step 154. Computer A receives the response in step 156, and in step 158 reads the response and discovers that the license remains deactivated. The transaction terminates in step 160 with the software application remaining the subject of a deactivated license and therefore requiring a further request for activation of the license at a later time.

The first embodiment described hitherto concerns the relatively simple situation where a software application can be executed on a particular computer with particular fixed rights according to whether or not a license is activated at that computer. Similar software applications can be executed at other computers likewise under the same fixed rights according to whether licenses are activated at these other computers, and a server 14 controls the activation and deactivation of licenses at each respective computer. In the example described, the license can be activated at only one computer in the system, computer A, and hence computers B and C will not have an activated license to execute the software application. It will readily be appreciated, however, that the system will operate in the same way if more than one activated license is to be available, and the server 14 will control the activation and deactivation of licenses in the same way through transactions between each computer and the server 14.

### 5. Second Embodiment

### Variable License Rights

The invention also envisages a more complex version of the system and method described with reference to FIGS. 1 to 4, and this second embodiment will now be described with reference to FIGS. 1, 2, 7 and 8.

Many parts of the system of, and method steps involved in, the second embodiment are the same as in the first embodiment and will be designated in the drawings by the same reference numerals. These parts and method steps will not be described again; only the differences will be described.

Referring to FIGS. 1 and 2, reference has already been made to the license file 30 in the disk drive 24 of each computer and to the records 30a for the serial number for the software application, 30b for status of the license, and 30c for the license rights for the associated computer. Likewise, reference has already been made to the database store 42 of the server 14 and the column 42a containing the serial numbers, the column 42b containing the computer identification for the computers where the license has been activated, and the further column 42c containing information concerning the license rights. In the case of the second embodiment, the further record 30c in the license file 30 and the further column 42c in the database store 42 both contain additional information concerning conditions under which the software application may be executed, that is information concerning the license rights. Such rights may include, by way of example only, a limitation on the number of times that the software application can be executed, a right to use the entire software application, a right to use specific features only of the software application, a right to a particular software capability, or access to certain restricted data.

When the server 14 activates the license at computer A, the server 14 may determine what rights shall be available at computer A and may activate the license in respect of one only, or some or all, of the rights that are possible. The server 14 enters details of the rights awarded to computer A in the license rights column 42c.

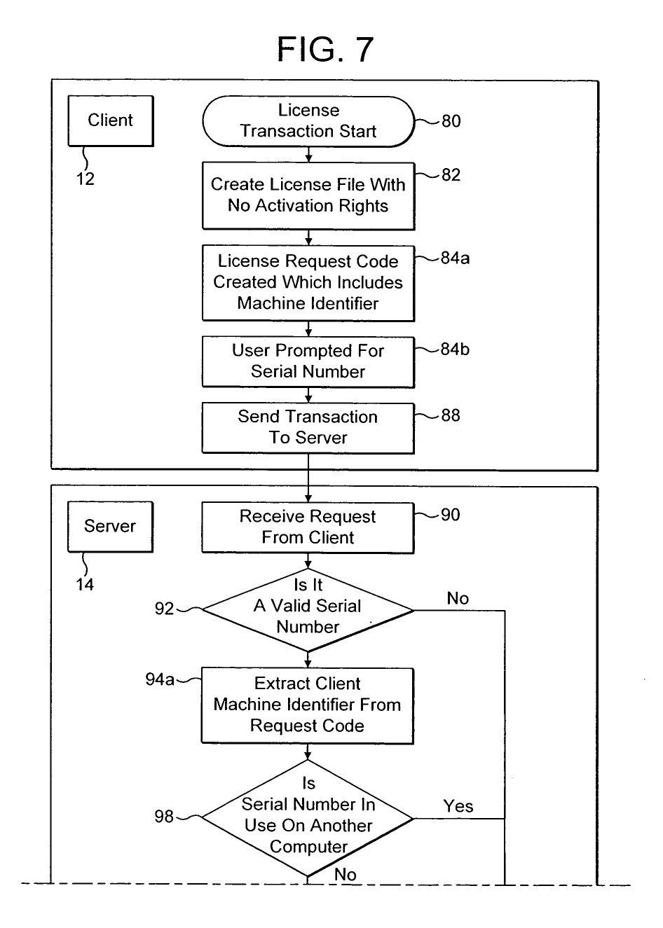

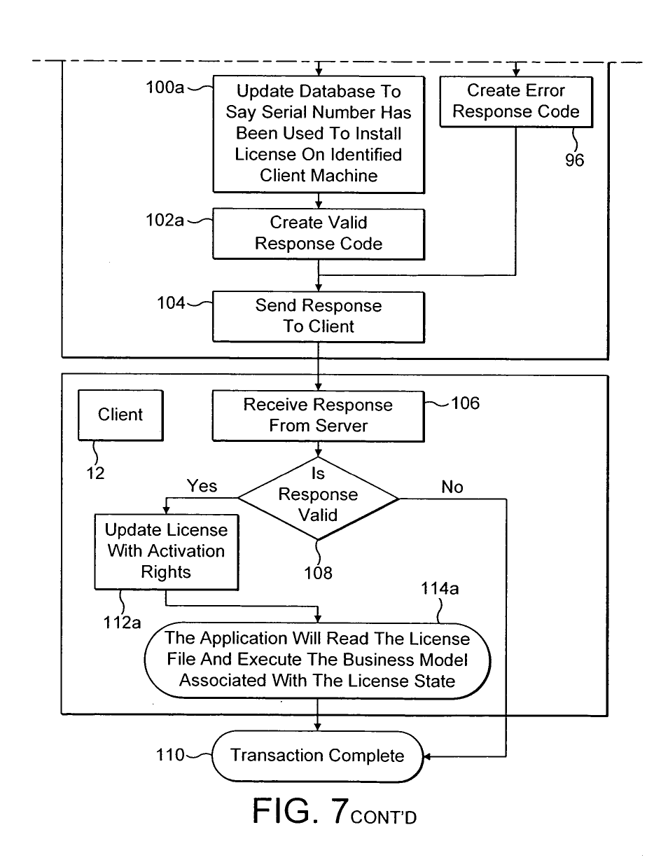

Turning to FIG. 7, it will be seen that the transaction between the client 12 at computer A and the server 14 in this event is similar to the transaction occurring in the first embodiment but is modified in the following respects:

Firstly, steps 84 and 86 of the transaction at the side of computer A, in which a license request is generated including an identification code for computer A and a serial number for the software application, are replaced by steps 84a and 86a. In step 84a, a license request code is generated including an identification code for computer A and a code for any license rights determined by the software application itself. Next, in step 86b, the user 12 is prompted for a serial number for the software application and also for any specific license rights required by the client 12 themselves. This combined license request is sent to the server in step 88 as before.

At the side of the server 14, steps 94 and 100, in which the identification code for computer A is extracted and the license file 42 at the server 14 is updated, are replaced by steps 94a and 100a. In step 94a, the server 14 extracts from the license request from computer A not only the identification code for computer A but also all information transmitted from computer A concerning the license rights requested from this computer. In step 100a, the server 14 updates the database store 42 not only by indicating in column 42b the identification code for computer A but also by indicating in column 42c the license rights awarded to computer A determining the conditions of use of the software application in this instance. In step 102 a corresponding response code is then generated by the server 14.

On receipt of the response code from the server 14, computer A checks the validity of the response in step 108 as before and, assuming the license is to be activated, proceeds to step 112a where the file record 30b is updated to indicate that the license has been activated and where the file record 30c is updated to indicate what license rights are available. Computer A will then proceed to step 114a, in which the software application will read the license file 30 and will execute the software application under the conditions of the available license rights.

During execution of the software application, the application will continually be updating the information in the license rights file record 30c so that the information is current. For example, if the license initially granted the right to run the software application 100 times, then on each occasion that the software application is executed, an execution count in the license rights folder 30c will be implemented by 1.

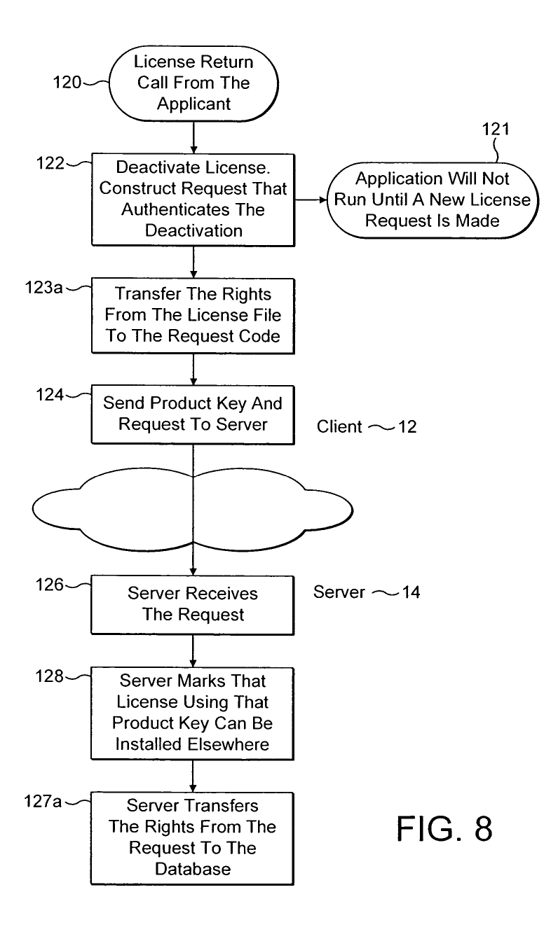

FIG. 8 shows the transaction that takes place, in this instance, when the license is to be deactivated. It will be seen that following the generation of a request to deactivate the license in step 122, a new step 123a is inserted in which the information in the license rights file record 30c is transferred to the request code. A deactivation request is sent from computer A to the server 14 in step 124a, as previously, with the exception that the request now includes details of the current state of the license rights in the request code. At the server 14, the database store 42 is updated in step 126 as before to indicate that computer A is no longer using the license and it can be activated elsewhere. Subsequently, in a further step 127a, the server 14 updates the column 42c to indicate the new state of the rights available under the license. In the example given above, if we assume that the license granted the right to execute the software application 100 times and computer A has executed the application 5 times, then the license rights column 42c will be updated with rights that to indicate that the license rights permit the software application to be executed a further 95 times.

As in the case of the first embodiment, requests received from computers B and C to activate the license while the license is activated at computer A will be denied insofar as the license rights requested at computers B and C are mutually exclusive with the rights already authorised for computer A. On the other hand, it will be appreciated that computers B or C might request the use of different rights from computer A and these might validly be authorised at the same time that the license is activated at computer A.

In the second embodiment, two additional features are present by comparison with the first embodiment. Firstly, selected license rights initiated by the client 12 may be requested of the server 14. Secondly, the rights may be arranged to vary on use, and the current state recorded in the license file 30 at the computer and then passed onto the server for updating of the server file 42.

### SUMMARY

Two embodiments of the present invention have been described above, both offering a system by which licenses for the execution of a given software application at different computers A, B and C may be reliably and simply controlled by means of a server 14, which retains a full history of the use of the software application at the different computers for reference. The result is a versatile and flexible system for controlling the use of software applications and the allocation of licenses and license rights for such applications.

An advantage of the present invention is that access to the server is only required when a license is transferred but is not required every time that the software application is run.

In both embodiments, it is possible also for the computers to be permitted to execute certain features under the software application even when the license is de-activated. For example, the computer may be allowed a certain number of days of free use of the software application, or the software application may prompt the computer for payment of a license fee etc.

It will be apparent that a number of modifications are possible within the scope of the invention. For example, the system need not be confined to the use of only one activated license but may cover as many license activations as desired, and also as many different forms of license rights as desired.

Numerous other variations and modifications may be made to the described embodiments without departing from the teachings and concepts of the present invention as defined in the claims.

1. A system for controlling the use of a software application on a plurality of computers, the system comprising:
a plurality of computers, each capable of running a given software application,
a server having a server store,
communication means respectively permitting communication between each said computer and said server, and
a transaction arrangement operable respectively between each said computer and said server by way of said communication means for enabling a predetermined use of said given software application by respective ones of said computers,
in which said server controls said predetermined use by means of said transaction arrangement and according to conditions stored in said server store.

2. A system according to claim 1 in which said transaction arrangement determines access of each said computer to said given software application.

3. A system according to claim 1 in which said transaction arrangement determines parameters of operation for said given software application.

4. A system according to claim 1 in which said server controls the number of said computers authorised to run said given software application.

5. A system according to claim 1 in which said given software application comprises at least one computer program operable under license, and in which said transaction arrangement comprises license management means for verifying the availability for a respective said computer of a said license for said at least one computer program.

6. A system according to claim 5 in which said license management means further comprise means for controlling license rights available under said license, and means for configuring said respective computer to operate according to said rights.

7. A system according to claim 5 in which said license management means comprise said server store, said server store for storing therein different possible license rights available under said license, selection means for selecting at least one said license right from said server store, and activation means for activating said at least one license right for a respective said computer.

8. A system according to claim 7 in which said license management means further comprise a store at said respective computer for storing details of said at least one license right, and means for updating said stored details on use of said computer program.

9. A system according to claim 5 in which said license management means are adapted to transfer a license from one said computer to another said computer.

10. A system according to claim 9 in which said license management means are arranged to inhibit operation of said computer program on said one computer following said transfer.

11. A license management system for controlling the use of at least one given software application respectively on a plurality of computers, said system comprising:
an application store associated with each said computer for storing a copy of said given software application;
a remote data store for storing information concerning a license to operate said at least one given software application;
a remote data store for storing identification information relating to said at least one given software application;
a remote data store for storing identification information relating to each said computer; and
a transaction arrangement operatively linking said application store, said license store, said software identification store and said computer identification store, said transaction arrangement being responsive to a request from a respective said computer for use of said at least one given software application to verify whether said at least one given software application is available for use by said respective computer and to transmit to said respective computer a said license to use said at least one given software application in the event that said at least one given software application is so available.

12. A license management system according to claim 11 comprising a server providing said license store, said software identification store and said computer identification store.

13. A license management system according to claim 11 in which said server controls the number of said licenses available.

14. A license management system according to claim 13 in which said server is adapted to transfer a license from one said computer to another said computer.

15. A license management system according to claim 14 in which said server is arranged to inhibit operation of said computer program on said one computer following said transfer.

16. A license management system according to claim 11 comprising a further license store provided at each said computer for storing locally information concerning said license.

17. A license management system according to claim 11 in which said transaction arrangement determines parameters of operation for said given software application.

18. A license management system according to claim 11 in which the said transaction arrangement comprises means for verifying the rights available under a said license.

19. A license management system according to claim 11 in which said license store has a data store for storing therein different possible license rights available under said license, and in which said transaction arrangement comprises selection means for selecting at least one said license right from said store, and activation means for activating said at least one license right for a respective said computer.

20. A license management system according to claim 19 in which said activation means comprise a license rights store associated with said respective computer for storing details of said at least one license right, and means for updating said license rights store according to the current state of said at least one license right on use of said computer program.

21. A computer programmed to perform a transaction for enabling the operation of a given software application, the transaction arrangement comprising:
creating a license file for a license to operate said given software application;
assigning to said license file a serial number representing said given software application;
assigning to said license file an identification code representing said computer;
transmitting to a server a request to execute said given software application;
transmitting with said request said serial number and said identification code;
in response to a server reply updating the license file with information concerning the availability of said license; and
reading said license file for establishing whether said given software application can be executed.

22. A computer programmed according to claim 21 in which said transaction arrangement further comprises:
in response to said server reply updating said license file with details of license rights transmitted from said server; and
configuring said computer according to said license rights to execute a predetermined software feature incorporated in said given software application.

23. A method for controlling the execution of a given software application on a plurality of computers in a computer system including a server, said method comprising the steps of:
creating a license file on a respective said computer for a license to operate said given software application;
license
assigning to the license file an identification code representing said respective computer;
formulating a request to execute said given software application at said respective computer, said request including a serial number associated with said given software application and said identification number;
transmitting said request with said serial number and said identification code to a server;
in response to a reply from said server updating the license file with information concerning the availability of said license; and
reading said license file for establishing the status of said license at said respective computer.

24. A method according to claim 23 further comprising:
storing at said server information concerning rights available under said license;
in response to said request from said respective computer selecting respective license rights to be applied to said respective computer and transmitting details of said selected rights to said respective computer;
in response to said server reply updating said license file with details of said selected license rights transmitted from said server; and
configuring said computer according to said selected license rights to execute a predetermined software feature incorporated in said given software application.

25. A method according to claim 24 further comprising:
updating said license file on an ongoing basis during use of said predetermined feature by said respective computer to record a current state of said license; and
when said license is no longer required transmitting details from said updated license file of said current state to said server.
